(19) United States
(12) Patent Application Publication
(10) Pub. No.: US 2014/0267591 A1
(43) Pub. Date: Sep. 18, 2014

(54) ELECTRONIC DEVICE AND METHOD OF OUTPUTTING IMAGE IN ELECTRONIC DEVICE

(71) Applicant: Samsung Electronics Co., Ltd., Suwon-si (KR)

(72) Inventor: Kyung-Heum YI, Suwon-si (KR)

(73) Assignee: Samsung Electronics Co., Ltd., Suwon-si (KR)

(21) Appl. No.: 14/208,720

(22) Filed: Mar. 13, 2014

Related U.S. Application Data
(60) Provisional application No. 61/783,438, filed on Mar. 14, 2013.

(30) Foreign Application Priority Data
Aug. 6, 2013 (KR) 10-2013-0093203

(51) Int. Cl. H04N 5/232

(52) U.S. Cl. CPC H04N 5/23238; H04N 5/23293
USPC 348/36

(57) ABSTRACT

An electronic device is provided. The electronic device includes a first layer configured to detect delta data from an image and to transmit the detected delta data to a camera application, when receiving the image in a panorama photographing mode, and a second layer configured to output a processed image as a preview image of the panorama photographing mode by using the delta data received from the first layer.

### CROSS-REFERENCE TO RELATED APPLICATION(S)

This application claims the benefit under 35 U.S.C. §119(e) of a U.S. Provisional application filed on Mar. 14, 2013 and assigned Ser. No. 61/783,438, and under 35 U.S.C. §119(a) of a Korean patent application filed on Aug. 6, 2013 in the Korean Intellectual Property Office and assigned Ser. No. 10-2013-0093203, the entire disclosure of each of which is hereby incorporated by reference.

### TECHNICAL FIELD

The present disclosure relates to an electronic device and a method of outputting an image in an electronic device. More particularly, the present disclosure relates to an electronic device and a method of outputting an image in the electronic device, which can improve a processing speed for displaying a preview image in a panorama photographing mode.

### BACKGROUND

In a panorama photographing mode which generates an image continuously lengthened in one direction, an electronic device including a camera displays a result of an image currently being photographed at a predetermined area of a screen of the electronic device, in order to guide a user through the panorama photographing process, while updating a result of the image to a preview image.

However, as a resolution of an image photographed through the camera of the electronic device has increased, a data size of an image processed in a panorama scheme in the panorama photographing mode has correspondingly increased.

Accordingly, an increasing amount of time delay occurs, so that an overload may occur. The overload of the system may reduce the processing speed for displaying the preview image in the panorama photographing mode.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least above-mentioned problems and/or disadvantages and to provide at least the advantages described below. Accordingly, an aspect of the present disclosure is to provide an electronic device and a method of outputting an image in the electronic device, which can improve a processing speed for displaying a preview image in a panorama photographing mode according to various embodiments of the present disclosure.

In accordance with an aspect of the present disclosure, an electronic device is provided. The electronic device includes a first layer configured to detect delta data from an image and to transmit the detected delta data to a camera application, when receiving the image in a panorama photographing mode, and a second layer configured to output a processed image as a preview image of the panorama photographing mode by using the delta data received from the first layer.

In accordance with another aspect of the present disclosure, a method of outputting an image in an electronic device is provided. The method includes detecting, by a first layer, delta data from an image, transmitting, by the first layer, the detected delta data to a second layer, when receiving the image in a panorama photographing mode, and outputting, by the second layer, a processed image as a preview image of the panorama photographing mode by using the delta data received from the framework.

An electronic device and a method of outputting an image in the electronic device according to various embodiments of the present disclosure may improve a processing speed for displaying a preview image in a panorama photographing mode.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a configuration of an electronic device according to an embodiment of the present disclosure;

FIG. 2 illustrates a configuration of a camera unit of an electronic device according to an embodiment of the present disclosure;

FIGS. 3A, 3B, 3C, and 3D are views for describing an operation of a framework in a panorama photographing mode of an electronic device according to an embodiment of the present disclosure;

FIGS. 4A, 4B, 4C, and 4D are views for describing an operation of a camera application in a panorama photographing mode of an electronic device according to various embodiments of the present disclosure;

FIG. 5 is a flowchart illustrating a process of outputting a preview image in a panorama photographing mode of an electronic device according to an embodiment of the present disclosure; and

FIG. 6 is a view for describing a process of outputting a preview image in a panorama photographing mode of an electronic device according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device according to various embodiments of the present disclosure includes a portable terminal and a stationary terminal. Here, the portable terminal corresponds to a portable and movable electronic device, and may include a video phone, a cellular phone, a smart phone, a Wideband Code Division Multiple Access (WCDMA) terminal, a Universal Mobile Telecommunication Service (UMTS) terminal, a Personal Digital Assistant (PDA), a Portable Multimedia Player (PMP), a Digital Multimedia Broadcasting (DMB) terminal, an Electronic ε-book, a portable computer (e.g., a notebook, a tablet Personal Computer (PC), etc.), a Digital Camera, etc. Further, the stationary terminal may include a desktop, a personal computer, etc.

Although in various embodiments of the present disclosure a first layer is described as a framework and a second layer is described as a camera application, the first layer is not limited to the framework, and the second layer is not limited to the camera application.

FIG. 1 illustrates a configuration of an electronic device according to an embodiment of the present disclosure. FIG. 2 illustrates a configuration of a camera unit of an electronic device according to an embodiment of the present disclosure. FIGS. 3A to 3D are views for describing an operation of a framework in a panorama photographing mode of an electronic device according to various embodiments of the present disclosure. FIGS. 4A to 4D are views for describing an operation of a camera application in a panorama photographing mode of an electronic device according to various embodiments of the present disclosure.

Referring to FIG. 1, a Radio Frequency (RF) unit 123 performs a wireless communication function of an electronic device. The RF unit 123 includes an RF transmitter which up-converts and amplifies a frequency of a signal to be transmitted, an RF receiver which low-noise-amplifies a received signal and down-converts a frequency, etc. A data processing unit 120 may include a transmitter which encodes and modulates the signal to be transmitted, a receiver which decodes and demodulates the received signal, etc. The data processing unit 120 may be configured by a MOdulator/DEModulator (MODEM) or a COder/DECoder (CODEC). Here, the CODEC may include a data CODEC for processing packet data, etc. and an audio CODEC for processing an audio signal such as voice, etc. An audio processing unit 125 may perform a function of reproducing a received audio signal output from the audio CODEC of the data processing unit 120 or transmitting an audio signal to be transmitted which is generated from a microphone, to the audio CODEC of the data processing unit 120.

A key input unit 127 may include keys for inputting number information and character information and function keys for setting various functions.

A memory 130 may be configured by a program memory, and a data memory. The program memory may store programs for controlling a general operation of the electronic device and programs for performing a control to improve a processing speed for displaying a preview image in a panorama photographing mode. Further, the data memory may perform a function of temporarily storing data generated while the programs are executed.

A controller 110 performs a function of controlling an overall operation of the electronic device.

The controller 110 may control a camera unit 140 to update a result of an image photographed while panorama photographing is performed in the panorama photographing mode to the preview image without a delay in processing time and to display the result of the image on a predetermined area of a display unit 160, according to various embodiments of the present disclosure.

The camera unit 140 may update a result of an image photographed while panorama photographing is performed in the panorama photographing mode to the preview image without the delay in the processing time and to display the result of the image on the predetermined area of the display unit 160, according to various embodiments of the present disclosure.

Referring to FIG. 2, in observing a configuration of the camera unit 140, the camera unit 140 may include a camera sensor 141, a special photographing processing unit 142, a framework 143, a camera application 144, and a Digital Signal Processing (DSP) unit 145.

The camera sensor 141 may photograph image data and convert a photographed optical signal into an electric signal.

The special photographing processing unit 142 may perform a function of processing an image photographed in a special photographing mode such as a panorama photographing mode, a smile shot mode, a beauty shot mode, etc. which are distinguished from a general photographing mode.

The special photographing processing unit 142 may process images continuously photographed while the panorama photographing is performed in the panorama photographing mode to a panorama image and may transmit the processed panorama image as a preview image of the panorama photographing mode to the framework 143, according to various embodiments of the present disclosure.

The framework 143 corresponds to a framework for the camera application 144, and may transmit the image received from the special photographing processing unit 142 in the special photographing mode, to the camera application 144.

The framework 143 may detect delta data from the image received from the special photographing processing unit 142 in the panorama photographing mode and may transmit the detected delta data to the camera application 144, according to various embodiments of the present disclosure. Further, the framework 143 may include a division unit 143a which can detect delta data from the image received from the special photographing processing unit 142 in the panorama photographing mode according to various embodiments of the present disclosure.

The division unit 143a may perform a specific calculation operation between the image received from the special photographing processing unit 142 and a previous image received immediately before in order, so as to detect delta data for an area which is different from the previous image, from the received image.

The delta data may include a delta image and delta information, and the delta information may include a delta direction and a delta size.

The image continuously received from the special photographing processing unit 142 in the panorama photographing mode corresponds to an image on which panorama processing is performed, and the size of the received image is different from that of the previous image received immediately before in order.

The division unit 143a may detect an image of the area which is different from the previous image, from the received image, as the delta image, detect the delta direction indicating a direction for the area which is different from the previous image, from the received image, and detect the delta size indicating the size of the delta image from the received image.

At this time, the delta direction may be determined by a photographing direction in which a user moves for photographing in the panorama photographing mode.

In a description of an operation of detecting the delta data by the division unit 143a, as illustrated in FIG. 3A, when an area which is different from a previous image 302 is detected at a left side of the received image 301 through a specific calculation operation between the image 301 and the previous image 302, the division unit 143a may detect the different area at the left side of the image 301 as a delta image 301a. Further, the division unit 143a may detect a delta direction (e.g., left) indicating a direction through a location of the delta image 301a in the image 301, and may detect the size (e.g., Width: 4 and Height: 80) of the delta image.

Further, as illustrated in FIG. 3B, when an area which is different from a previous image 312 is detected at a right side of the received image 311 through a specific calculation operation between the image 311 and the previous image 312, the division unit 143a may detect the different area at the right side of the image 311 as a delta image 311a. The division unit 143a may detect a delta direction (e.g., right) indicating a direction through a location of the delta image 311a in the image 311, and may detect the size (e.g., Width: 4 and Height: 80) of the delta image.

Further, as illustrated in FIG. 3C, when an area which is different from a previous image 322 is detected at a lower side of the received image 321 through a specific calculation operation between the image 321 and the previous image 322, the division unit 143a may detect the different area at the lower side of the image 321 as a delta image 321a. The division unit 143a may detect a delta direction (e.g., down) indicating a direction through a location of the delta image 321a in the image 321, and may detect the size (e.g., Width: 80 and Height: 4) of the delta image.

Further, as illustrated in FIG. 3D, when an area which is different from a previous image 332 is detected at an upper side of the image 331 through a specific calculation operation between the image 331 and the previous image 332, the division unit 143a may detect the different area at the upper side of the image 331 as a delta image 331a. The division unit 143a may detect a delta direction (e.g., up) indicating a direction through a location of the delta image 331a in the image 331, and may detect the size (e.g., Width: 80 and Height: 4) of the delta image.

The camera application 144 may transmit the image received from the framework 143 in the special photographing mode, to the DSP unit 145.

The camera application 144 may generate an image by using the delta information received from the framework and output the generated image as a preview image of the panorama photographing mode, according to various embodiments of the present disclosure.

The camera application 144 may include a merging unit 144a which can generate an image by using the delta information received from the framework, according to various embodiments of the present disclosure.

When receiving the delta data from the framework 143, the merging unit 144a may generate an image which is the same as the image received from the special photographing processing unit 142 by the framework 143, by merging a delta image included in the delta data to the previous image output as the preview image of the panorama photographing mode, by using the delta direction and delta size included in the delta data, according to various embodiments of the present disclosure.

An operation of detecting the preview image in the panorama photographing mode by using the delta data by the merging unit 144a will be described with reference to FIGS. 4A to 4D. As illustrated in FIG. 4A, when receiving delta data 401 from the framework 143, the merging unit 144a may merge a delta image 401 a to a left side of a previous image 402 output as a preview image of the panorama photographing mode through a delta direction (e.g., left) of the delta data 401, and then generate the merged image 403.

Further, as illustrated in FIG. 4B, when receiving from delta data 411 from the framework 143, the merging unit 144a may merge a delta image 411a to a right side of a previous image 412 output as a preview image of the panorama photographing mode through a delta direction (e.g., right) of the delta data 411, and then generate the merged image 413.

Further, as illustrated in FIG. 4C, when receiving from delta data 421 from the framework 143, the merging unit 144a may merge a delta image 421a to an upper side of a previous image 421 output as a preview image of the panorama photographing mode through a delta direction (e.g., up) of the delta data 422, and then generate the merged image 423.

Further, as illustrated in FIG. 4D, when receiving from delta data 431 from the framework 143, the merging unit 144a may merge a delta image 431a to a lower side of a previous image 431 output as a preview image of the panorama photographing mode through a delta direction (e.g., down) of the delta data 432, and then generate the merged image 433.

The DSP unit 145 may convert an analog signal of the image received from the camera application 144 into a digital signal and transmit the converted digital signal to an image processing unit 150 of FIG. 1.

The image processing unit 150 performs Image Signal Processing (ISP) for displaying an image signal output from the camera unit 140 to the display unit 160, and the ISP performs a function such as gamma correction, interpolation, a spatial change, an image effect, image scaling, Automatic White Balance (AWB), Automatic Focusing (AF), Automatic Exposure (AE), etc. Thus, the image processing unit 150 processes the image signal output from the camera unit 140 in a unit of a frame, and outputs the frame image data in accordance with a characteristic and a size of the display unit 160. Further, the image processing unit 150 includes an image CODEC and performs a function of compressing the frame image data displayed on the display unit 160 in a set scheme or decompressing the compressed frame image data to the original frame image data. Here, the image CODEC may include a Joint Photographic Experts Group (JPEG) CODEC, a Motion Picture Experts Group 4 (MPEG4) CODEC, a Wavelet CODEC, etc. It is assumed that the image processing unit 150 may include a function of an On-Screen-Display (OSD), and the image processing unit 150 may output OSD data according to a size of a screen displayed under the control of the controller 110.

The display unit 160 displays the image signal output from the image processing unit 150 on the screen and displays user data output from the controller 110. Here, the display unit 160 may employ a Liquid Crystal Display (LCD) panel, in which case the display unit 160 may include an LCD controller, a memory for storing image data, an LCD element, etc. Here, when the LCD is realized in a touch screen scheme, the display unit 160 may operate as an input unit, and at this time, keys such as the key input unit 127 may be displayed on the display unit 160.

Further, when the display unit 160 is realized in the touch screen scheme so that the display unit 120 is used as the touch screen unit, the touch screen unit may be formed by a Touch Screen Panel (TSP) including a plurality of sensor panels, and the plurality of sensor panels may include a capacitive sensor panel which can recognize a hand touch and an electromagnetic sensor panel which can detect a touch such as by a touch pen.

An operation of displaying a preview image in the panorama photographing mode of the electronic device will be described in detail with reference to FIGS. 5 to 6.

FIG. 5 is a flowchart illustrating a process of outputting a preview image in a panorama photographing mode of an electronic device according to an embodiment of the present disclosure. FIG. 6 is a view for describing a process of outputting a preview image in a panorama photographing mode of an electronic device according to an embodiment of the present disclosure.

Hereinafter, embodiments of the present disclosure will be described in detail with reference to also FIGS. 1 and 2.

Referring to FIG. 5, while the panorama photographing is processed in operation 501 corresponding to the panorama photographing mode of the electronic device, the photographed image may be processed into the panorama image by the special photographing processing unit 142, and the processed panorama image may be transmitted to the framework 143. The framework 143 may determine whether the image is received from the special photographing processing unit 142, in operation 502.

When it is determined in operation 502 that the image is received from the special photographing processing unit 142, the framework 143 may determine whether there is a previous image received immediately before in order, in operation 503.

However, when it is determined in operation 502 that the image is not received from the special photographing processing unit 142, the reception of the image from the special photographing processing unit 142 may be on standby.

When it is determined in operation 503 that there is no previous image, the framework 143 may determine the image received from the special photographing processing unit 142 as an image firstly photographed in the panorama photographing, and may transmit the image to the camera application 144, in operation 504.

In operation 505, the camera application 144 may determine whether the image is received from the framework 143.

When it is determined in operation 505 that the image is received from the framework 143, the camera application 144 may perform an operation of outputting the image received from the framework 143 as a preview image of the panorama photographing mode, in operation 506.

However, when it is determined in operation 505 that the image is not received from the framework 143, the reception of the image from the framework 143 may be on standby.

Further, when it is determined in operation 503 that there is the previous image, the framework 143 may transmit the image received from the special photographing processing unit 142, to the division unit 143a.

In operation 507, the division unit 143a may perform a specific calculation operation between the image received from the special photographing processing unit 142 and the previous image, so as to detect an area which is different from the previous image, from the received image. In operation 507, the division unit 143a may detect an image of the detected different area as a delta image, detect a direction according to a location of the delta image within the received image as a delta direction, and detect a delta size indicating a size of the delta image.

When the delta image, the delta direction and the delta size are detected by the division unit 143 a, the framework 143 may transmit delta data including the delta image and the delta information (e.g., the delta direction and the delta size) to the camera application 144 in operation 508.

In operation 509, the camera application 144 may determine whether the delta data is received from the framework 143.

When it is determined in operation 509 that the delta data is received from the framework 143, the camera application 144 may transmit the received delta data to the merging unit 144a. Further, when it is determined in operation 509 that the delta data is not received from the framework 143, the camera application 144 may wait for the reception of the delta data from the framework.

In operation 510, the merging unit 144a may generate an image obtained by merging the delta image included in the delta data to the previous image output as the preview image of the panorama photographing mode before in order by using the delta information included in the received delta data, e.g., the delta direction and the delta size, and the merged image may be the same image which the framework 143 has received from the special photographing processing unit 142.

When the merged image which is the same image which the framework 143 has received from the special photographing processing unit 142 is generated, the camera application 144a may output the merged image as the preview image of the panorama photographing mode, in operation 511.

The operation of FIG. 5 will be described with an example with reference to FIG. 6. In a case where a first image 601 processed as a panorama image is received from the special photographing processing unit 142 in the panorama photographing mode, when there is no previous image received before in order, the division unit 143a of the framework 143 may transmit the first image 601 which is a first image photographed in the panorama photographing mode, to the camera application 144. If so, the camera application 144 may output the first image 601 as the preview image of the panorama photographing mode.

Next, when a second image 602 processed as the panorama image is received from the special photographing processing unit 142, the division unit 143a of the framework 143 may perform a specific calculation operation between the first image 601 received before in order and the received second image 602 to detect a delta image 602a, which is an area different from the first image 601, from the second image 602 and may transmit the delta image 602a and the delta information (e.g., a delta direction (e.g., right) indicating a direction for the delta image 602a and a delta size indicating a size of the delta image 602a), to the camera application 144. The merging unit 144a of the camera application 144 may merge the delta image 602a to a right side of the first image 601, which is a previous image previously output as a preview image of the panorama photographing mode, by using the delta information (e.g., the delta direction (e.g., right) and the delta size) and may output the merged image corresponding to the second image 602 as a preview image of the panorama image.

Next, when a third image 603 processed as the panorama image is received from the special photographing processing unit 142, the division unit 143a of the framework 143 may perform a specific calculation operation between the second image 602 received before in order and the received third image 603 to detect a delta image 603a, which is an area different from the second image 602, from the third image 603 and may transmit the delta image 603a and the delta information (e.g., a delta direction (e.g., right) indicating a direction for the delta image 603a and a delta size indicating a size of the delta image 603a), to the camera application 144. The merging unit 144a of the camera application 144 may merge the delta image 603a to a right side of the second image 602, which is a previous image previously output as a preview image of the panorama photographing mode, by using the delta information (e.g., the delta direction (e.g., right) and the delta size) and may output the merged image corresponding to the third image 603 as a preview image of the panorama image.

While the panorama photographing is performed in the panorama photographing mode, the aforementioned operations are repeatedly performed, and the preview images of the panorama photographing displayed on a predetermined area of the display unit 160 may be processed and displayed with an improved speed without delay.

The electronic device and the method of outputting the image in the electronic device according to various embodiments of the present disclosure may be realized by a computer-readable code in a non-transitory computer-readable recording medium. The non-transitory computer-readable recording medium includes all types of recording devices which store data readable by a computer system. Examples of the recording medium include a Read-Only Memory (ROM), a Random Access Memory (RAM), an optical disk, a magnetic tape, a floppy disk, a hard disk, a nonvolatile memory, etc. Further, the non-transitory computer-readable recording medium may be dispersed in computer systems connected through a network, and a computer-readable code may be stored and executed in a dispersion scheme.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a first layer configured to detect delta data from an image and to transmit the detected delta data to a second layer, when receiving the image in a panorama photographing mode; and
the second layer configured to generate a preview image of the panorama photographing mode by using the delta data received from the first layer.

2. The electronic device of claim 1, wherein the first layer is configured to detect delta data for an area which is different from a previous image, from the received image, through a calculation operation between the received image and the previous image, and to transmit the detected delta data to the second layer.

3. The electronic device of claim 1, wherein the first layer is configured to detect an image of the area which is different from the previous image, from the received image, as a delta image, to detect a delta direction indicating a direction for the area which is different from the previous image, from the received image, to detect a delta size indicating a size of the delta image, and to transmit the delta data comprising the delta image, the delta direction and the delta size, to the second layer.

4. The electronic device of claim 3, wherein the delta direction is determined according to a direction of panorama photographing in the panorama photographing mode.

5. The electronic device of claim 1, wherein the first layer is configured to successively receive images of which the sizes are different from each other, which are obtained by panorama processing in the panorama photographing mode.

6. The electronic device of claim 1, wherein the first layer comprises a division unit configured to detect the delta data from an image received in the panorama photographing mode.

7. The electronic device of claim 1, wherein the second layer is configured to generate a preview image of the panorama photographing mode which is the same image as the image received by the first layer by using the delta data received from the first layer and the previous image.

8. The electronic device of claim 1, wherein the second layer is configured to generate a preview image of the panorama photographing mode which is the same image as the image received by the first layer by merging a delta image of the delta data to the previous image by using a delta direction and a delta size of the delta data when receiving the delta data from the first layer.

9. The electronic device of claim 1, wherein the second layer comprises a merging unit configured to generate an image by using the delta data received from the first layer.

10. The electronic device of claim 1, wherein the first layer comprises a framework, and the second layer comprises a camera application.

11. A method of outputting an image in an electronic device, the method comprising:
detecting, by a first layer, delta data from an image;
transmitting, by the first layer, the detected delta data to a second layer, when receiving the image in a panorama photographing mode; and
generating, by the second layer, a preview image of the panorama photographing mode by using the delta data received from the first layer.

12. The method of claim 11, wherein the transmitting comprises:
performing, by the first layer, a calculation operation between the received image and a previous image;
detecting, by the first layer, delta data for an area which is different from the previous image, from the received image, through the calculation operation; and
transmitting, by the first layer, the detected delta data to the second layer.

13. The method of claim 12, wherein the detecting of the delta data comprises:
detecting, by the first layer, an image of the area which is different from the previous image, from the received image, as a delta image;
detecting, by the first layer, a delta direction indicating a direction for the area of the received image which is different from the previous image;
detecting, by the first layer, a delta size indicating a size of the delta image, by the first layer; and
detecting, by the first layer, the delta data comprising the delta image, the delta direction and the delta size.

14. The method of claim 13, wherein the delta direction is determined according to a direction of panorama photographing in the panorama photographing mode.

15. The method of claim 11, wherein the transmitting comprises:
successively receiving, by the first layer, images of which the sizes are different from each other, which are obtained by panorama processing in the panorama photographing mode.

16. The method of claim 11, wherein the generating comprises:
generating, by the second layer, a preview image of the panorama photographing mode which is the same image as the image received by the first layer by using the delta data received from the first layer and the previous image.

17. The method of claim 11, wherein the outputting comprises:
generating, by the second layer, a preview image of the panorama photographing mode which is the same image as the image received by the first layer by merging a delta image of the delta data to the previous image by using a delta direction and a delta size of the delta data when receiving the delta data from the first layer.

18. The method of claim 11, wherein the first layer comprises a framework, and the second layer comprise a camera application.

19. A non-transitory computer-readable recording medium storing a program for performing the method defined in claim 11.
